(19) United States
(12) Patent Application Publication
(10) Pub. No.: US 2012/0212469 A1
(43) Pub. Date: Aug. 23, 2012

(54) DISPLAY DRIVING CIRCUIT AND METHOD

(75) Inventor: Tse-Hung Wu, New Taipei City (TW)

(73) Assignee: NOVATEK MICROELECTRONICS CORP., Hsinchu (TW)

(21) Appl. No.: 13/371,483

(22) Filed: Feb. 13, 2012

(30) Foreign Application Priority Data
Feb. 18, 2011 (TW) 100105500

(51) Int. Cl. G09G 5/00

(52) U.S. Cl. 345/209

(57) ABSTRACT

A display driving circuit adapted to drive multiple display channels of a display panel is provided. The display channels include a first set channel, a second set channel, a third set channel, and a fourth set channel respectively having an alternate change between a first voltage polarity and a second voltage polarity. Adjacent two set channels are operated by the first voltage polarity and second voltage polarity. A switching unit has four switches respectively connected to adjacent two of the four set channels. A switch control circuit conducts the four switches in a sequence. In a first stage, anyone of the switches is conducted for a period. In a second stage, other two switches connected to two terminals of the conducted switch are conducted for a period. In a third stage, another switch serially connected between the two conducted switches in the second stage is conducted for a period.

### CROSS-REFERENCE TO RELATED APPLICATION

This application claims the priority benefit of Taiwan application serial no. 100105500, filed Feb. 18, 2011. The entirety of the above-mentioned patent application is hereby incorporated by reference herein and made a part of this specification.

### BACKGROUND

1. Field of the Invention

The invention relates to a display driving technique. Particularly, the invention relates to a display driving technique having a charge recycling function.

2. Description of Related Art

A digital display mechanism has been widely applied to large-scale display systems such as televisions or small-scale display systems such as mobile electronic devices. A display method of the digital display is to display images through a pixel array. Generally, a display panel of the display requires a gate driver to activate corresponding scan lines. Moreover, a source driver is used to input operation voltages to individual pixels on the scan line. Variation of the operation voltage corresponds to a gray level variation of the pixel, and the pixel is taken as a unit to form a complete image.

In collaboration with a semiconductor structure of the pixel and improvement of operation efficiency, a plurality of inversion driving techniques is not all positive voltage polarity, but have an alternate change of positive and negative voltage polarities. Such driving method is the so-called inversion driving method. Under the inversion driving mode, when the positive polarity driving is changed to the negative polarity driving, a load on the pixel has to be correspondingly charged.

The load is equivalent to a capacitor, and when the voltage polarity is changed, it takes some time to achieve a required operation voltage. In order to increase an operation rate, the driving method is achieved through a pre-charging method. Further, according to the conventional driving mechanism, residual charges on the pixel can be recycled for providing to other pixels of a different polarity. A main driving method of a general display panel is to use a source driving circuit to write a voltage required by liquid crystal, and during a process of voltage inversion, only a charge distribution method is used to counteract the positive polarity charges and the negative polarity charges, which is limited for reducing power consumption.

Different charge recycling methods have different effectiveness, which are required to be continually researched and developed.

### SUMMARY OF THE INVENTION

The invention is directed to a display driving circuit and method, which can achieve an effect of low power consumption.

The invention provides a display driving circuit, adapted to drive a plurality of display channels of a display panel, where the display channels are divided into at least one channel unit, and the channel unit includes four set channels, and each set channel has an alternate change of a first voltage polarity and a second voltage polarity opposite to each other. The display driving circuit includes at least one switch unit, and each switch unit has four switches respectively connected between adjacent two of the four set channels, where anyone of the four switches serves as a first stage switch, other two of the four switches serve as two second stage switches and are connected to two terminals of the first stage switch, and another one of the fourth switches serves as a third stage switch and is connected between the two second stage switches. A switch control circuit sequentially conducts the first stage switch to the third stage switch for a predetermined time.

The invention provides a display driving method, adapted to drive a plurality of display channels of a display panel. The display driving method includes dividing the display channels into at least one channel unit, where the channel unit includes four set channels, and each set channel has an alternate change of a first voltage polarity and a second voltage polarity opposite to each other. Then, four switches are provided to respectively connect between adjacent two of the four set channels, where anyone of the four switches serves as a first stage switch, other two of the four switches serve as two second stage switches and are connected to two terminals of the first stage switch, and another one of the fourth switches serves as a third stage switch and is connected between the two second stage switches. Moreover, the display channels are disconnected from a driver. Further, charge recycling is performed, and the first stage switch to the third stage switch are sequentially conducted for a predetermined time.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit schematic diagram of a display driving circuit according to an embodiment of the invention.

FIG. 2 is a schematic diagram illustrating a charge recycling mechanism of a display driving circuit according to an embodiment of the invention.

FIG. 3 is a schematic diagram illustrating a charge recycling mechanism started from a switch SW(N) according to an embodiment of the invention.

FIG. 4 is a schematic diagram illustrating a charge recycling mechanism started from a switch SW(N+2) according to an embodiment of the invention.

FIG. 5 is a schematic diagram illustrating a charge recycling mechanism started from a switch SW(N+3) according to an embodiment of the invention.

FIG. 6 is a schematic diagram illustrating a charge recycling mechanism started from a switch SW(N+1) according to an embodiment of the invention.

### DETAILED DESCRIPTION OF DISCLOSED EMBODIMENTS

Considering saving more power consumption generated when a liquid crystal display (LCD) drives positive and negative polarities, a charge distribution method used during the driving operation is limited in capability for reducing power consumption. In the invention, a novel charge recycling method is used to store charges of a load capacitor of a previous polarity to another load capacitor, and before inverting to another polarity, the charges stored in the other load capacitor are used to pre-charge to the load capacitor. The LCD using such charge recycling method has relatively less power consumption. The charge recycling mechanism does not require an extra storage capacitor, and compared to the conventional charge recycling method requiring the extra storage capacitor, a panel design can be simplified and the cost can be reduced.

Embodiments are provided below for describing the invention, though the invention is not limited to the provided embodiments, and the embodiments can be suitably combined.

The display driving mechanism of the invention is adapted to the LCD, though it is not limited to the charge recycling driving method of the LCD. Further, the display driving method is not limited to a liquid crystal inversion driving method and a display of positive and negative polarity arrangement. The inversion driving method of the invention is, for example, column inversion, row inversion or N-dot inversion, etc. Each time before the polarity inversion, two sets or more than two sets of load capacitors respectively having the positive and negative polarities are connected for charge distribution. Then, charges of other two sets or more than two sets of load capacitors respectively having the positive and negative polarities are recycled to the aforementioned two sets or more than two sets of the load capacitors respectively having the positive and negative polarities. Then, the aforementioned other two sets or more than two sets of load capacitors respectively having the positive and negative polarities are connected for charge distribution.

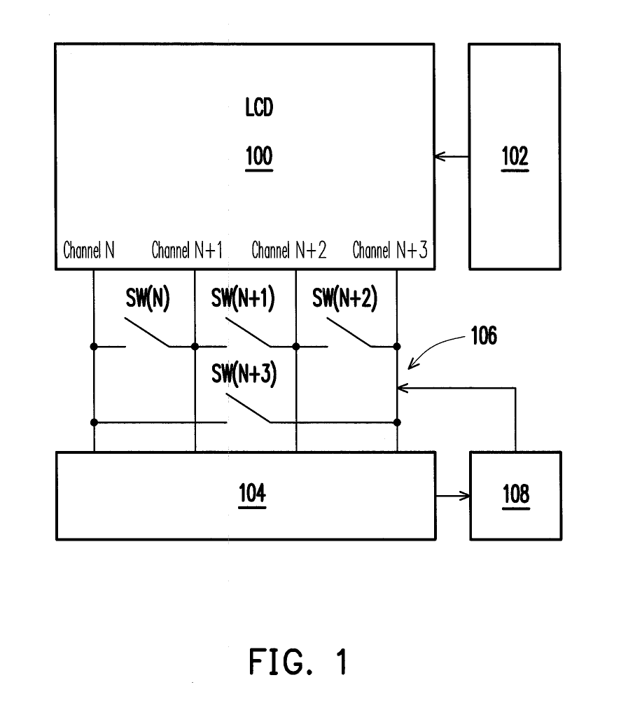

FIG. 1 is a circuit schematic diagram of a display driving circuit according to an embodiment of the invention. Referring to FIG. 1, a display panel 100 of a pixel array is, for example, a LCD array. According to a display timing of the display panel 100, a driving 102 of one direction, for example, a gate driver activates pixels to be displayed, and a driver 104 of another direction, for example, a source driver inputs voltage values of corresponding pixel gray levels to the corresponding pixels. Each output terminal of the driver 104 is correspondingly connected to a channel. The multiple channels can be divided into four set channels of N, N+1, N+2 and N+3 according to polarity variation. In the charge recycling mechanism of the invention, one switch unit 106 is connected between the four set channels. The switch unit 106 has fourth switches SW(N), SW(N+1), SW(N+2) and SW(N+3), which are respectively connected between the four set channels in a recycling manner. Turning on/off of the switch unit 106 is controlled by a switch control unit 108. In the present embodiment, the switch control unit 108 is separately configured, however it can also be built in the driver 104 or at any suitable place. The switch control unit 108 broadly represents any circuit capable of controlling four switches. The driver 104 of the invention is not limited to the source driver, and any driven channel requiring charge recycling can use the driver 104.

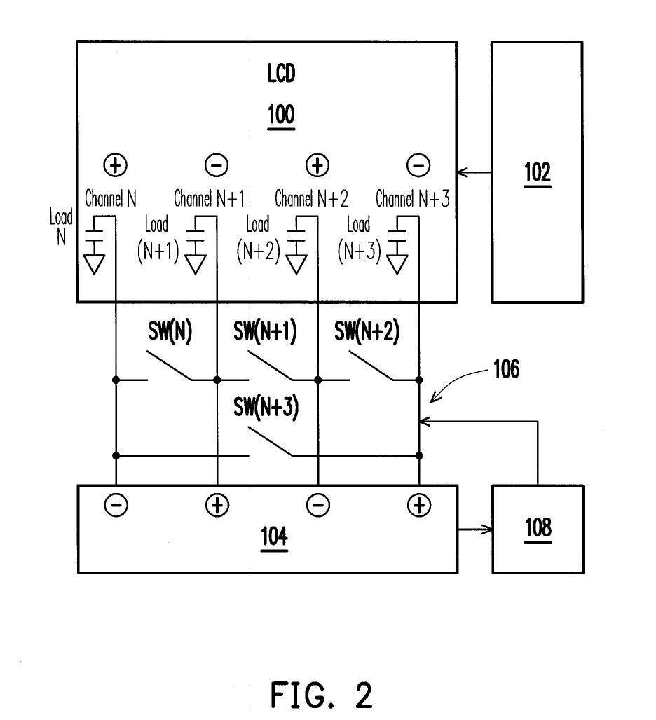

The charge recycling mechanism is described in detail below. FIG. 2 is a schematic diagram illustrating the charge recycling mechanism of the display driving circuit according to an embodiment of the invention. Referring to FIG. 2, the display panel 100 has a plurality of display channels, and the display channels can be divided into at least one channel unit. Taking one channel unit as an example, it includes four set channels N, N+1, N+2 and N+3. In other words, one set channel can be connected to a single channel or multiple channels of a same operation polarity. The whole display panel 100 can be controlled by one switch unit 106 or a plurality of the switch units 106.

Each set channel has an alternate change of a first voltage polarity and a second voltage polarity opposite to each other, and adjacent two set channels are operated by the first voltage polarity and the second voltage polarity. If the first voltage polarity is a positive polarity, the second voltage polarity is a negative polarity. Further, if the first voltage polarity is the negative polarity, the second voltage polarity is the positive polarity. Symbols of “+” and “−” above the channels on the display panel 100 represent polarities generated by residual charges on channel loads relative to a common voltage. Symbols of “+” and “−” on the driver 104 represent next polarity variations of the connected channels. The load on the channel is equivalent to a load capacitor, and one end thereof is connected to the common voltage, which is, for example, a ground voltage.

The switch unit 106 has fourth switches SW(N), SW(N+1), SW(N+2) and SW(N+3), which are respectively connected between adjacent two of the four set channels. During operation, as described later, anyone of the four switches serves as a first stage switch. Other two of the four switches serve as two second stage switches and are connected to two terminals of the first stage switch, and another one of the fourth switches serves as a third stage switch and is connected between the two second stage switches. The switch control circuit 108 sequentially conducts the first stage switch, the second stage switches and the third stage switch for a predetermined time.

Regarding a connecting method of the switches, the switch SW(N) is, for example, connected between the first set channel N and the second set channel N+1. The switch SW(N+1) is connected between the second set channel N+1 and the third set channel N+2. The switch SW(N+2) is connected between the third set channel N+2 and the fourth set channel N+3. The switch SW(N+3) is connected between the fourth set channel N+3 and the first set channel N.

The charge recycling mechanism is described with reference of a timing relation of switch control signals. For simplicity's sake, it is assumed that absolute values of the voltage value on the channels N, N+1, N+2, and N+3 relative to the common voltage are the same, and the common voltage is, for example, the ground voltage. During an actual operation, different gray levels correspond to different voltage values. However, according to a same charge recycling sequence, it still has a charge recycling effect.

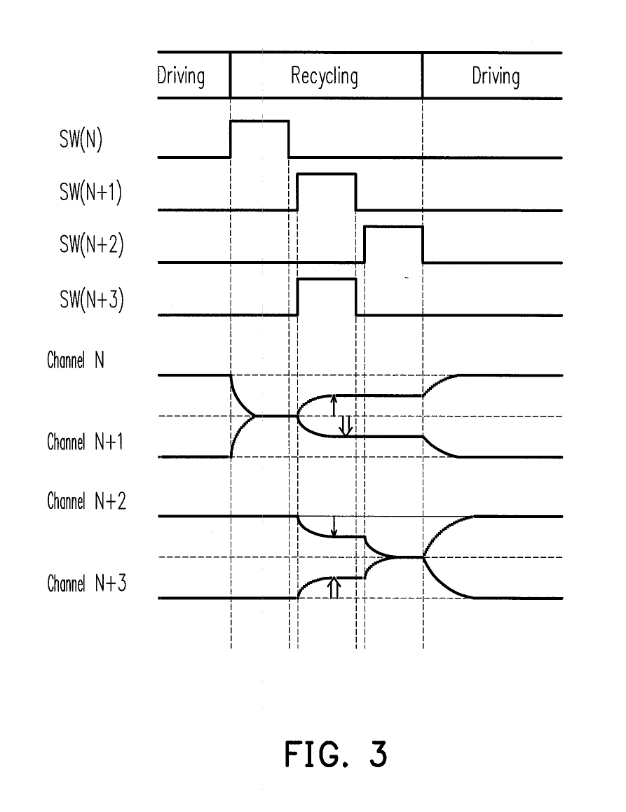

FIG. 3 is a schematic diagram illustrating a charge recycling mechanism started from the switch SW(N) according to an embodiment of the invention. Referring to FIG. 3, before the charge recycling starts, the output terminals of the driver 104 are disconnected to the load channels. In the present embodiment, the switch SW(N) serves as a first stage switch and is conducted for a period. When the switch SW(N) is conducted, the charges of the channel N and the channel N+1 are balanced to the common voltage, which is represented by a dot line. The switch SW(N) is disconnected after being conducted for the period. In a second stage, the switch SW(N+1) and the switch SW(N+3) are conducted, and the load charges on the channel N+2 and the channel N+3 are respectively transferred to the channel N+1 and the channel N. As shown by arrows, a part of positive charges on the channel N+2 is transferred to the channel N+1, and a part of negative charges on the channel N+3 is transferred to the channel N. Partial charge recycling is completed during the second stage. After the second stage, the switch SW(N+1) and the switch SW(N+3) are disconnected. In a third stage, the switch SW(N+2) is conducted to balance the load charges on the channel N+2 and the channel N+3 to complete the charge recycling operation. Now, the channel N is changed from the positive polarity to the negative polarity, and the channel N+1 is changed from the negative polarity to the positive polarity. Further, the channel N+2 is changed from the positive polarity to the common voltage, and the channel N+3 is changed from the negative polarity to the common voltage. Then, the driving circuit outputs to charge/discharge all of the loads to start driving, so as to reach the voltage values and polarities of the corresponding gray levels.

As mentioned above, if bias values of the channel N and the channel N+1 relative to the common voltage are different, or bias values of the channel N+2 and the channel N+3 relative to the common voltage are different, when the switch SW(N) and the switch SW(N+3) are conducted, a balance voltage thereof is deviated from the common voltage, though it still approaches the common voltage, and the charge recycling mechanism still exists.

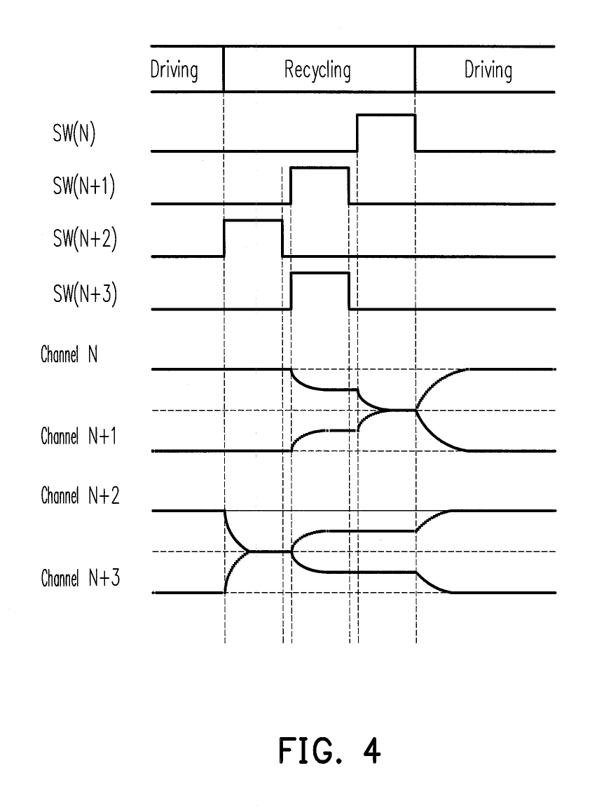

FIG. 4 is a schematic diagram illustrating a charge recycling mechanism started from the switch SW(N+2) according to an embodiment of the invention. Referring to FIG. 4, before the charge recycling is started, the output terminals of the driver 104 are disconnected to the load channels. In the present embodiment, the switch SW(N+2) serves as the first stage switch. The switch SW(N+2) is conducted to balance the charges on the channel N+2 and the channel N+3. In the second stage, the switch SW(N+1) and the switch SW(N+3) are conducted, and the charges on the channel N+1 and the channel N are respectively transferred to the channel N+2 and the channel N+3. In the third stage, the switch SW(N) is conducted to balance the charges on the channel N and the channel N+1 to complete the charge recycling operation. Then, the driving circuit outputs to charge/discharge all of the loads to start driving.

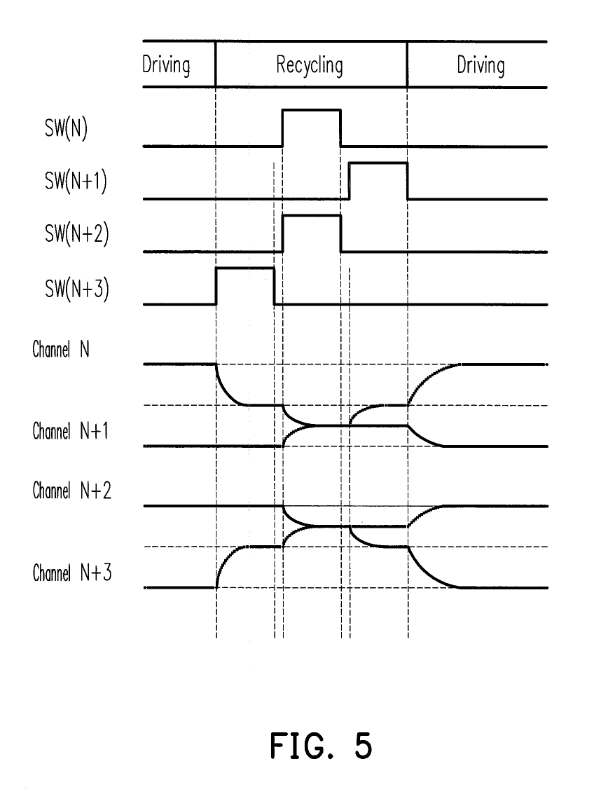

FIG. 5 is a schematic diagram illustrating a charge recycling mechanism started from the switch SW(N+3) according to an embodiment of the invention. Referring to FIG. 5, before the charge recycling starts, the output terminals of the driver 104 are disconnected to the load channels. In the present embodiment, the switch SW(N+3) serves as the first stage switch. The switch SW(N+3) is conducted to balance the charges on the channel N and the channel N+3. In the second stage, the switch SW(N) and the switch SW(N+2) are conducted, and the charges on the channel N+1 and the channel N+2 are respectively transferred to the channel N and the channel N+3. In the third stage, the switch SW(N+1) is conducted to balance the charges on the channel N+1 and the channel N+2 to complete the charge recycling operation. Then, the driving circuit outputs to charge/discharge all of the loads to start driving.

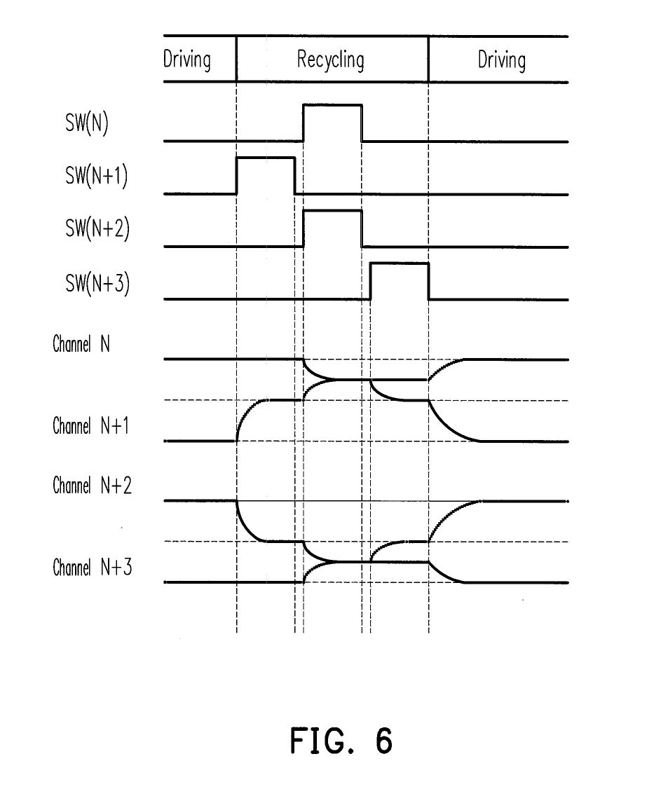

FIG. 6 is a schematic diagram illustrating a charge recycling mechanism started from the switch SW(N+1) according to an embodiment of the invention. Referring to FIG. 6, before the charge recycling starts, the output terminals of the driver 104 are disconnected to the load channels. In the present embodiment, the switch SW(N+1) serves as the first stage switch. The switch SW(N+1) is conducted to balance the charges on the channel N+1 and the channel N+2. In the second stage, the switch SW(N) and the switch SW(N+2) are conducted, and the charges on the channel N and the channel N+3 are respectively transferred to the channel N+1 and the channel N+2. In the third stage, the switch SW(N+3) is conducted to balance the charges on the channel N and the channel N+3 to complete the charge recycling operation. Then, the driving circuit outputs to charge/discharge all of the loads to start driving.

According to the charge recycling operations of the above three stages, a pre-charging effect is achieved, and when the driver drives the pixels on the channels, the required charges are reduced to reduce the power consumption.

Further, the switch control of the second stage does not necessarily require conducting two switches. Simultaneous conduction of two switches may reduce the operation time, though it is not a necessary condition.

Moreover, as mentioned above, the channel N, the channel N+1, the channel N+2 and the channel N+3 respectively represent one set of channel having the same operation polarity, and an actual channel number thereof is one or plural, which is determined according to an actual design requirement. In addition, the number of the switch control units 106 is determined according to the number of the planned channel units. The charge recycling mechanism controlled by the switch control unit 106 is not limited to a fixed type, and multiple charge recycling mechanisms can be executed in timing.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display driving circuit, adapted to drive a plurality of display channels of a display panel, wherein the display channels are divided into at least one channel unit, and the channel unit comprises four set channels, and each set channel has an alternate change of a first voltage polarity and a second voltage polarity opposite to each other, the display driving circuit comprising:
at least one switch unit, each switch unit having four switches respectively connected between adjacent two of the four set channels, wherein anyone of the four switches serves as a first stage switch, other two of the four switches serve as two second stage switches and are connected to two terminals of the first stage switch, and another one of the fourth switches serves as a third stage switch and is connected between the two second stage switches; and
a switch control circuit, sequentially conducting the first stage switch to the third stage switch for a predetermined time.

2. The display driving circuit as claimed in claim 1, wherein the four switches comprise a first switch, a second switch, a third switch and a fourth switch, and the four set channels comprise a first set channel, a second set channel, a third set channel and a fourth set channel, wherein the first switch is connected between the first set channel and the second set channel, the second switch is connected between the second set channel and the third set channel, the third switch is connected between the third set channel and the fourth set channel, and the fourth switch is connected between the fourth set channel and the first set channel

3. The display driving circuit as claimed in claim 1, wherein the first switch is the first stage switch, the second switch and the fourth switch are the two second stage switches, and the third switch is the third stage switch.

4. The display driving circuit as claimed in claim 1, wherein the second switch is the first stage switch, the first switch and the third switch are the two second stage switches, and the fourth switch is the third stage switch.

5. The display driving circuit as claimed in claim 1, wherein the third switch is the first stage switch, the second switch and the fourth switch are the two second stage switches, and the first switch is the third stage switch.

6. The display driving circuit as claimed in claim 1, wherein the fourth switch is the first stage switch, the first switch and the third switch are the two second stage switches, and the second switch is the third stage switch.

7. The display driving circuit as claimed in claim 1, wherein relative to a polarity of a common voltage, the first voltage polarity is a positive voltage polarity and the second voltage polarity is a negative voltage polarity, or the first voltage polarity is the negative voltage polarity and the second voltage polarity is the positive voltage polarity.

8. The display driving circuit as claimed in claim 1, wherein a number of each set of the four set channels is one or plural having the same polarity.

9. The display driving circuit as claimed in claim 1, wherein the switch unit is connected to the channel unit or connected to a plurality of the channel units.

10. A display driving method, adapted to drive a plurality of display channels of a display panel, comprising:
dividing the display channels into at least one channel unit, wherein the channel unit comprises four set channels, and each set channel has an alternate change of a first voltage polarity and a second voltage polarity opposite to each other;
providing four switches to respectively connect between adjacent two of the four set channels, wherein anyone of the four switches serves as a first stage switch, other two of the four switches serve as two second stage switches and are connected to two terminals of the first stage switch, and another one of the fourth switches serves as a third stage switch and is connected between the two second stage switches;
disconnecting the display channels from a driver; and
performing charge recycling, and sequentially conducting the first stage switch, the second stage switches and the third stage switch for a predetermined time.

11. The display driving method as claimed in claim 10, wherein after the step of charge recycling is completed, the display channels are connected to the driver.

12. The display driving method as claimed in claim 10, wherein the four switches comprise a first switch, a second switch, a third switch and a fourth switch, and the four set channels comprise a first set channel, a second set channel, a third set channel and a fourth set channel, wherein the first switch is connected between the first set channel and the second set channel, the second switch is connected between the second set channel and the third set channel, the third switch is connected between the third set channel and the fourth set channel, and the fourth switch is connected between the fourth set channel and the first set channel.

13. The display driving method as claimed in claim 10, wherein the first switch is the first stage switch, the second switch and the fourth switch are the two second stage switches, and the third switch is the third stage switch.

14. The display driving method as claimed in claim 10, wherein the second switch is the first stage switch, the first switch and the third switch are the two second stage switches, and the fourth switch is the third stage switch.

15. The display driving method as claimed in claim 10, wherein the third switch is the first stage switch, the second switch and the fourth switch are the two second stage switches, and the first switch is the third stage switch.

16. The display driving method as claimed in claim 10, wherein the fourth switch is the first stage switch, the first switch and the third switch are the two second stage switches, and the second switch is the third stage switch.

17. The display driving method as claimed in claim 10, wherein relative to a polarity of a common voltage, the first voltage polarity is a positive voltage polarity and the second voltage polarity is a negative voltage polarity, or the first voltage polarity is the negative voltage polarity and the second voltage polarity is the positive voltage polarity.

18. The display driving method as claimed in claim 10, wherein a number of each set of the four set channels is one or plural having the same polarity.

19. The display driving method as claimed in claim 10, wherein the switch unit is connected to the channel unit or connected to a plurality of the channel units.
